(19) United States
(12) Patent Application Publication
(10) Pub. No.: US 2007/0173251 A1
(43) Pub. Date: Jul. 26, 2007

(54) Validation of mobile stations in unlicensed radio access networks

(76) Inventors: Jari Vikberg, Jarna (SE); Tomas Nylander, Vermdo (SE); Magnus Hallenstal, Taby (SE); Bo Luppert, Sodertalje (SE); Peter L. Ohman, Enebyberg (SE)

Correspondence Address: ERICSSON INC., 6300 LEGACY DRIVE, M/S EVR 1-C-11, PLANO, TX, 75024, US

(21) Appl. No.: 11/568,234

(22) PCT Filed: Apr. 26, 2004
(86) PCT No.: PCT/EP04/04396

§ 371 Date: Oct. 24, 2006

(51) Int. Cl. H04Q 7/20

(52) U.S. Cl. 455/428; 370/328; 370/395.52

(57) ABSTRACT

An unlicensed-radio access network includes an access controller (303) adapted to communicate with the core network portion of a public mobile communication network (20) and connected to a broadband packet-switched network (302). The access controller receives messages from mobile stations via the broadband packet-switched network. The access controller comprises a screening module (3031-3034) for monitoring information received from a mobile station and a connection controller (3035) coupled to the screening module for controlling the connection between the mobile station and the access controller. The screening module is adapted to determine whether a mobile station is permitted to connect to the access controller, and the connection controller is adapted to terminate a connection with the mobile station if the screening module determines that the mobile station is not permitted to connect to the access controller.

### FIELD OF THE INVENTION

The present invention relates to the authentication of mobile stations accessing a cellular communication system via an unlicensed radio access network.

### BACKGROUND ART

In conventional cellular networks, such as GSM, for example, the identity of a mobile station is checked and its operation and right to access the network authenticated using various elements within the core network portion, such as the Home Location Register (HLR), the Equipment Identity Register (EIR) and the authentication centre (AUC).

Conventional cellular networks can be extended by the provision of unlicensed radio access networks, which include an access network controller for interfacing with the core network portion of a conventional cellular system and for controlling a plurality of access points adapted to communicate with mobile stations over an unlicensed radio interface. The unlicensed radio interface may use any radio technology that does not require an operating license from a licensing authority and in particular may use wireless LAN (WLAN), Bluetooth or DECT radio technologies. While a mobile station that uses an unlicensed radio access network to access a cellular system may be authenticated in the same way as for a conventional access network, however, defective mobile stations can put a heavy operational load on both the access network and the core network, for example when they generate Location Updates or other information in a loop. Also, since mobile stations capable of accessing an unlicensed radio access network will require some modification over conventional mobile stations, an additional level of validation becomes necessary, specifically as to whether a mobile station is authorised to use such an access network and whether this mobile station is authorised to access the core network portion via this unlicensed radio access network.

### SUMMARY OF THE INVENTION

It is thus an object of the present invention to enable the authentication and validation of mobile stations using an unlicensed radio access network that minimizes the load on both the access network and the core network it connects to.

It is a further object of the present invention to enable the authentication and validation of mobile stations for use with an unlicensed access network.

These and further objects are achieved in an unlicensed radio access network and a method of validation of a mobile station in an unlicensed radio access network in accordance with the appended claims.

Specifically, the unlicensed radio access network according to the present invention includes an access controller that is adapted to communicate with the core network portion of a public mobile communication network and is connected to a broadband packet-switched network. The access controller is adapted to receive messages from mobile stations communicating via an unlicensed radio interface with access points connected to the broadband packet-switched network. The access controller comprises a screening module for monitoring information received from a mobile station and a connection controller coupled to the screening module for controlling the connection between the mobile station and the access controller. In particular, the screening module is adapted to determine whether a mobile station is permitted to connect to said access controller, and the connection controller is adapted to terminate a connection with the mobile station if the screening module determines that the mobile station is not permitted to connect to the access controller.

The provision of a screening function within the access network ensures that access to mobile core network resources is denied as soon as possible to unauthorised users and equipment.

Preferably, the screening module includes a module for extracting at least part of a subscriber identity from information received from said mobile station to obtain a network operator identity for said mobile station. A table containing permitted and/or barred network operator identities is coupled to the subscriber identity extractor module, and the subscriber identity extractor module is adapted to compare an extracted network operator identity with network operator identities stored in the table to determine whether the extracted network operator identity is valid and consequently whether the mobile station should be permitted to connect to the access controller and through this to the core network portion. In this manner only those mobile stations belonging to a network that is authorised to use the core network will be permitted to register with the access network and subsequently connect to the core network portion.

In accordance with a further embodiment of the invention, the screening module includes a module for extracting at least part of an equipment identity from information received from said mobile station. This module compares the extracted equipment identity with a list of permitted and/or barred equipment identities to determine whether said extracted equipment identity is authorised.

The screening module may additionally, or alternatively include a module for monitoring traffic between the mobile station and the access controller and from the mobile station to the core network portion. This monitoring module is adapted to signal to the connection controller to terminate the connection with the mobile station if it determines that the pattern of transactions initiated in said mobile station is abnormal. Such a module serves as an additional protection to the core network portion and also to the access controller by identifying defective and possibly malicious behavior that threatens to undermine the core network operation, and by terminating the communication rapidly and cleanly.

This traffic or transaction monitoring is performed in a particularly simple manner, when communication between a mobile station and the access controller takes place on an open connection. The monitoring module is then adapted to monitor an open connection between a mobile station and the access controller. This is achieved, for example, when communication over the broadband network uses a protocol that maintains a connection state in the broadband network between the mobile station and the access controller.

In order to avoid having to process repeated attempts to register by a mobile station that has been denied access due to abnormal behavior, a register associated with a mobile station is provided. This register is controlled by the connection controller, and is set by the connection controller when the connection with the mobile station is terminated. The connection controller then denies access to this mobile station while said register is set. Additionally a timer may be provided that is adapted to reset the register after a predetermined time period.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically depicts parts of a GSM network with an unlicensed-radio access network,

FIG. 2 is a block diagram schematically depicting the functional layout of the unlicensed-radio access controller in accordance with the present invention,

FIG. 3 is a flow diagram illustrating the function of part of the unlicensed radio access controller in accordance with the present invention, and

FIG. 4 is a flow diagram illustrating the function of a further part of the unlicensed radio access controller in accordance with the present invention.

### DETAILED DESCRIPTION OF THE DRAWINGS

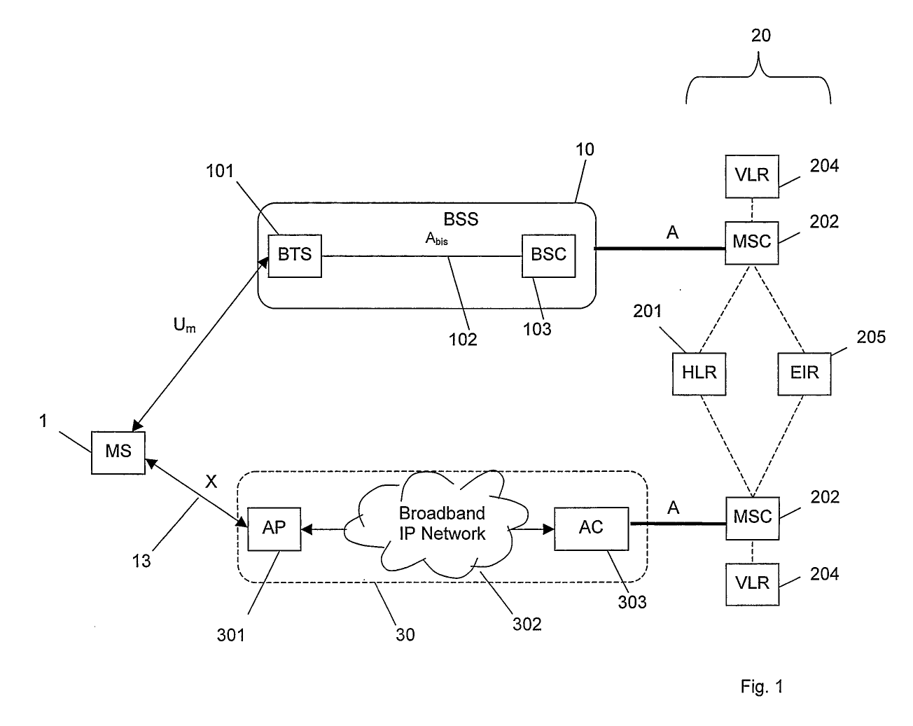

FIG. 1 schematically depicts parts of a conventional GSM network. This network is essentially divided into a core network portion 20 and an access portion also known as a base station subsystem BSS 10. The elements of the core network 20 illustrated in the figure include the mobile switching centers or MSCs 202, associated home location register HLR 201 and visitor location register VLR 204. The function and structure of these conventional GSM architecture elements are known to those skilled in the art and will not be described in further detail here. Although not shown in the figure, it will be understood by those skilled in the art that the core network portion may include access to other mobile and fixed-line networks, such as ISDN and PSTN networks, packet and circuit switched packet data networks such as intranets, extranets and the Internet through one or more gateway nodes. Also illustrated in the figure is the Equipment Identity Register EIR 205, which is a database that stores the identity of mobile equipment in the form of the International Mobile Equipment Identity IMEI and is used primarily to prevent calls from stolen, unauthorised or defective mobile stations.

The access portion essentially consists of base station subsystems BSS 10, one of which is illustrated in FIG. 1, which communicate via defined fixed standard A interfaces with MSCs 202 in the core network portion 20. Each base station subsystem BSS 10 includes a base station controller BSC 103 which communicates with one or more base transceiver stations BTS 101 via the defined A_{bis} air interface 102. The base transceiver stations 101 communicate with mobile stations MS 1 over the GSM standard Uₘ radio air interface. It will be understood that while the BTS 101 and BSC 103 are depicted as forming a single entity in the BSS 10, the BSC 103 is often separate from the BTSs 101 and may even be located at the mobile services switching centre MSC 202.

In addition to the standard access network portion provided by the BSS's 10 the network depicted in FIG. 1 further includes a modified access network portion 30 shown in the lower half of the figure. Hereinafter this will be described as an unlicensed-radio access network portion.

The components making up this unlicensed-radio access network portion 30 also enable the mobile station 1 to access the GSM core network portion, and through this, other communication networks via an unlicensed-radio interface X, represented in FIG. 1 by the bi-directional arrow 13. By unlicensed-radio is meant any radio protocol that does not require the operator running the mobile network to have obtained a license from the appropriate regulatory body. In general, such unlicensed-radio technologies must be low power and thus of limited range compared to licensed mobile radio services. This means that the battery lifetime of mobile stations will be greater. Moreover, because the range is low, the unlicensed-radio may be a broadband radio, thus providing improved voice quality. The radio interface may utilize any suitable unlicensed-radio protocol, for example a wireless LAN (W-LAN) protocol or Digital Enhanced Cordless Telecommunications (DECT). Preferably, however, Bluetooth radio is utilised, which has a high bandwidth and lower power consumption than conventional public mobile network radio.

The Bluetooth standard specifies a two-way digital radio link for short-range connections between different devices. Devices are equipped with a transceiver that transmits and receives in a frequency band around 2.45GHz. This band is available globally with some variation of bandwidth depending on the country. In addition to data, up to three voice channels are available. Each device has a unique 48-bit address from the IEEE 802 standard. Built-in encryption and verification is also available.

The access network portion 30 is accessed via access points AP 301 that are adapted to communicate across the Bluetooth interface. Only one access point AP 301 is illustrated in FIG. 1, but it will be understood that many hundreds of these elements may be included in the unlicensed-radio access network 30. This element handles the radio link protocols with the mobile station MS 1 and contains radio transceivers that define a cell in a similar manner to the operation of a conventional GSM base station transceiver BTS 101. All communication via the access points AP 301 is controlled by an access controller AC 303, which communicates with a mobile service switching centre MSC 202 over the GSM standard A interface. The access controller AC 303 provides the connection between the MSC 202 and mobile station 1. The joint function of the access point AP 301 and the access controller AC 303 emulates the operation of the BSS 10 towards the MSC 202. In other words, when viewed from the elements of the core network 20 such as the mobile service switching centre MSC 202, the access network portion 30 constituted by the access points AP 301 and the access controller AC 303 looks like a conventional access network portion 10.

The interface between the access point AP 301 and the access controller AC 303 is provided by a packet-switched broadband network, which may be a fixed network. The access point 301 is intended to be a small device that a subscriber can purchase and install in a desired location such as the home or an office environment to obtain a fixed access to the mobile network. However, they could also be installed by operators in traffic hotspots. In order to reduce the installation costs on the part of the operator, the interface between the access point 301 and the access controller 303 preferably exploits a connection provided by an already existing network 302. Suitable networks might include those based on ADSL, Ethernet, LMDS, or the like. Home connections to such networks are increasingly available to subscribers while access points to such networks are becoming widespread in public and commercial buildings. Although not shown in FIG. 1, the access point AP 301 will be connected to a network terminal giving access to the network 302, while the access controller AC 303 may be connected to an edge router ER of the network 302 that also links the network 302 to other networks such as intranets and the internet. The Internet protocol, IP, is used for communication over the network 302 to render the transport of data independent of the network type.

The access point AP 301 may serve as a dedicated access point to the unlicensed-radio access network. In this case the access point AP 301 is capable of communicating independently with the mobile station 10 over the unlicensed-radio interface X or with the access controller 303 over the broadband network interface 302. The access point AP 301 utilizes the standard protocols and functions to ascertain to which access controller AC 303 it should connect, and also to establish a connection and register with this access controller AC 303.

In an alternative embodiment, the access point 301 serves as an essentially transparent access point when viewed both from the access controller 303 and the mobile station 1. In other words, this access point relays all information at the IP level and above between the mobile station 1 and the access controller 303. It simply effects the conversion between the OSI reference model layer 1 and 2 unlicensed-radio and terrestrial access layer services. Accordingly, the mobile station 1 establishes a connection with the access controller 303 without recognising the access point as a node in the connection. Similarly the access controller 303 could establish a connection with the mobile station 1 directly.

The link between the mobile station MS 1 and the access controller AC 303 over the broadband IP network 302 is always open, so that this connection is always available without the need for reserving a channel. Specifically, a transport protocol is utilised that maintains a connection state between a mobile station MS 1 and the access controller AC 303. One suitable transport protocol is the Transmission Control Protocol (TCP), however, other protocols such as the User Datagram Protocol (UDP) or the Signaling Control Transfer Protocol could also be used. While the network 302 is preferably an IP-based network, ATM-based networks could also be used. In particular when DSL technologies are used in this network, they could be used directly on top of the ATM layer, since they are based on ATM. Naturally, an ATM based network could also be used to transport IP, serving as a base layer.

The applications that run on the mobile station MS 1 on top of the public mobile network radio interfaces also run on top of Bluetooth radio between the mobile station 1 and the access point AP 301.

The access point AP 301 is installed by plugging it in to a port of a suitable modem, such as an ADSL or CATV modem, to access the fixed network 302. Alternatively, the access point AO 301 could be integrated in such a modem. The port is in contact with an intranet that is either bridged or routed on the IP level.

In a conventional GSM network or other public licensed mobile network PLMN, such as CDMA2000 or UTMS, a mobile station is authenticated and validated when it registers with a network. In a GSM system the Equipment Identity Register EIR typically contains three lists of International Mobile Equipment Identities IMEI for mobile stations that are barred, that are to be tracked and that are valid. The mobile services switching center MSC queries the EIR when a mobile station registers with the network to determine whether the mobile can be allowed to use the service. A further level of security is provided by an authentication center AUC. This links the International Mobile Subscriber Identity IMSI to authentication and encryption parameters to verify a users identity and ensure the confidentiality of each call. In both cases, the mobile station is authenticated and verified in the core network portion of the network.

In accordance with the present invention, an additional level of security is provided in the unlicensed access network so that unauthorised mobile stations can be prevented from accessing the core network portion. In addition mobile stations that behave in an unusual manner can be identified and barred from the network. By filtering the mobile stations in the unlicensed radio access network the core network is protected. In addition, this permits the right of access to the unlicensed radio access network itself to be verified.

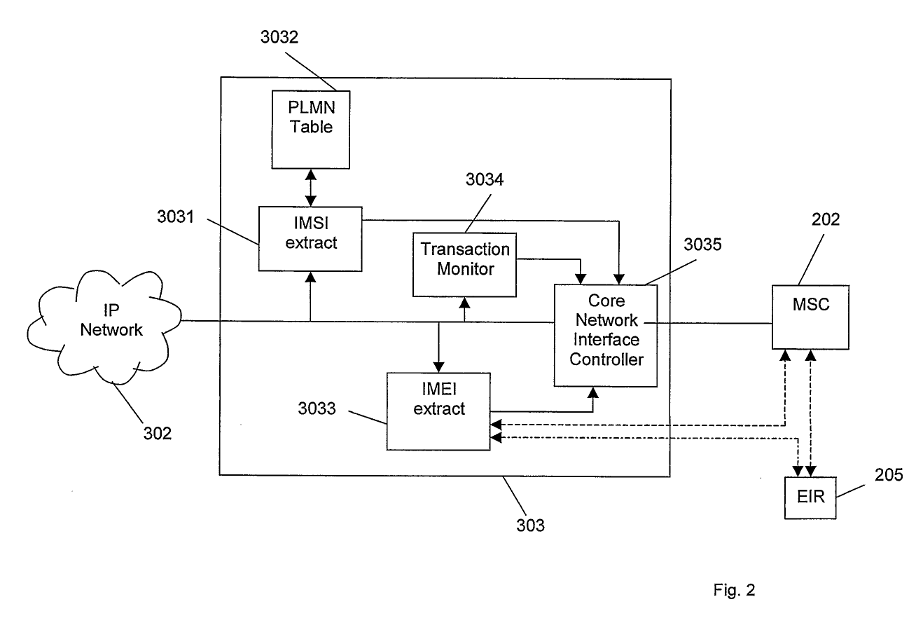

FIG. 2 shows a functional block diagram of those parts of the unlicensed radio access network controller AC 303 that permit this additional level of security in accordance with the present invention. As shown in FIG. 2 the access controller AC 303 is connected to the broadband IP network 302 and all communications to and from the mobile stations MS 1 occurs via this IP network 302. The access controller AC 303 is further connected to a mobile services switching center MSC 202 in the core network portion of the PLMN. Although not illustrated in the figures, the access controller AC 303 could also provide access to the General Packet Radio Service GPRS by providing a Gb interface to a GPRS support node (SGSN).

In accordance with the simplified block structure of the access controller AC 303 as depicted in FIG. 2, communications originating from a mobile station MS 1 are passed to the core network portion 20 by a core network interface controller 3035, which either passes messages by converting them to the standard A (or Gb) interface or blocks access to the core network portion 20. Three further functional blocks are shown connected to this core network interface controller 3035. Depending on the information received from these three blocks, the core network interface controller 3035 either permits or denies access to the core network 20. A first block 3031 extracts the International Mobile Subscriber Identity IMSI from a registration request received from a mobile station MS 1 via the IP network 302. The IMSI is composed of three parts: a mobile country code MCC, which consists of three digits and uniquely identifies the country of domicile of the mobile subscriber; a mobile network code MNC, consisting of two or three digits for GSM applications and which identifies the home GSM network (i.e. the network operator) of the mobile subscriber; and a mobile subscriber identification number MSIN, which identifies the mobile subscriber within a GSM PLMN. The first two parts of the IMSI, namely the MCC and MNC, serve to identify a mobile operator or PLMN. The IMSI extractor 3031 is connected to a database or memory 3032 containing a table of PLMNs. This database 3032 may include a list of PLMNs to which the unlicensed radio access network is permitted to provide access, or a so-called “white list”. In other words the table will list all PLMNs that have a roaming or similar agreement with the core network accessed via the unlicensed radio access network. Alternatively, or in addition, the database 3032 may include a black list of PLMNs listing those PLMNs for which no access can be obtained via the unlicensed radio access network. After obtaining the IMSI from the mobile station, the IMSI extractor retrieves the MCC and MNC portions to obtain a PLMN identifier, which it compares with the PLMN identifiers contained in the table or tables 3032. If the PLMN identifier corresponds to a permitted PLMN, the mobile station MS 1 is permitted to register and obtain access to both the access network and core network resources. Conversely if the PLMN identifier does not correspond to an allowed PLMN the mobile station registration is rejected and access to the core network is blocked.

A second, optional, block is an International Mobile Equipment Identifier IMEI extractor 3033. If the mobile station includes an IMEI in its registration request or is requested to do so by the access or core networks, this block extracts the IMEI from the registration message. This block then sends a query containing the received IMEI to the Equipment Identity Register EIR 205 via the mobile services switching center MSC 202 in the core network portion. As mentioned above, the Equipment Identity Register EIR 205 lists the International Mobile Equipment Identities IMEI of mobile stations that are barred, that are to be tracked and that are valid. Depending on the response to the query, the IMEI extractor block 3033 signals to the core network interface controller 3035 to either permit or deny registration of the mobile station. In an alternative embodiment, the IMEI extractor 3033 is capable of interfacing with the Equipment Identity Register EIR 205 directly without having to pass the query through the mobile services switching center MSC 202. This is illustrated in the figure by a dot-dashed double-headed arrow between these two elements. In a still farther embodiment, not illustrated in FIG. 2, the EIR functionality is incorporated in the access controller 303, for example as a separate table or database, and is updated from the EIR 205 in the core network periodically.

The third block that intercepts communication between mobile stations MS 1 and the core network portion 20 is a transaction monitor 3034. This block operates only after registration of a mobile station MS 1 with the access and core network and serves to monitor the behavior of a mobile station. As mentioned above, once a mobile station is registered with the access controller AC 303, the connection through the IP network 302 between a mobile station MS 1 and the access controller AC 303 is always open, even when a mobile station is idle. There is no need to reserve channels, nor is it necessary to identify each communication separately, since all traffic on a designated open connection will originate from the same mobile station MS 1. Accordingly, the transaction monitor 3034 is able to monitor all traffic originating in a single mobile station MS 1. If the number of transactions started by the mobile station is too high, indicating defective operation or a malicious intent to destabilize the core network, the transaction monitor 3034 will signal the core network interface controller 3035 to terminate access for this mobile station to the core network. This could be the case, for example, if a mobile station is generating location update messages too often as a result of a loop. Such a transaction could cripple the mobile services switching center 202. At the same time as forcing the mobile station MS 1 out of the system, the core network interface controller 3035 also sets a register indicating that the mobile station should be denied access in the future. This register is preferably linked to a timer, so that after a predetermined time period, such as a number of days, for example, the register is reset and the mobile station MS 1 may reattempt registration to the access controller AC 303.

The separate block structure illustrated in FIG. 2 is given by way of example only. It will be appreciated by those skilled in the art that the function of all three elements could alternatively be accomplished by a single or groups of processors with the appropriate memory.

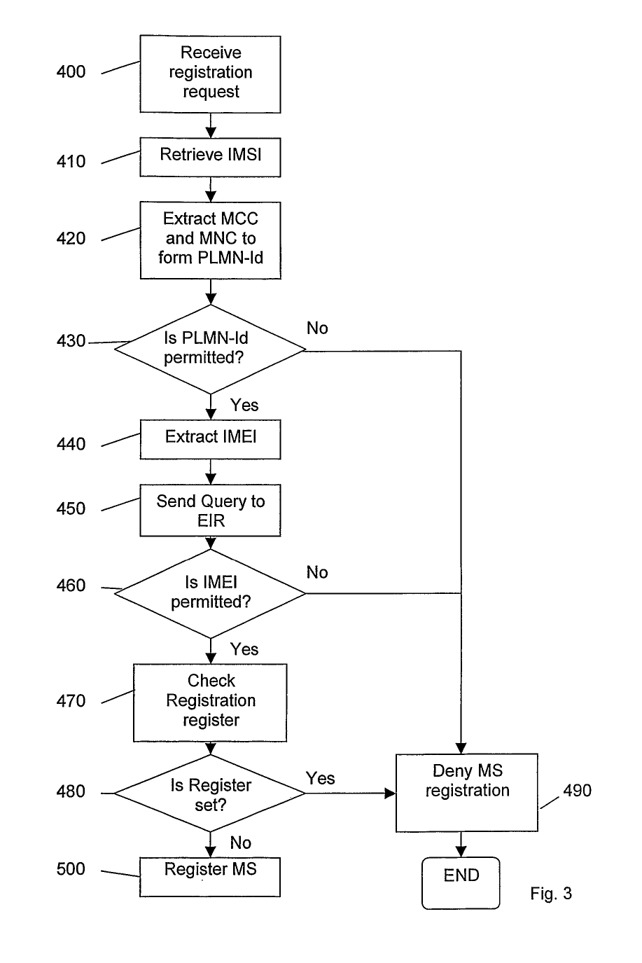

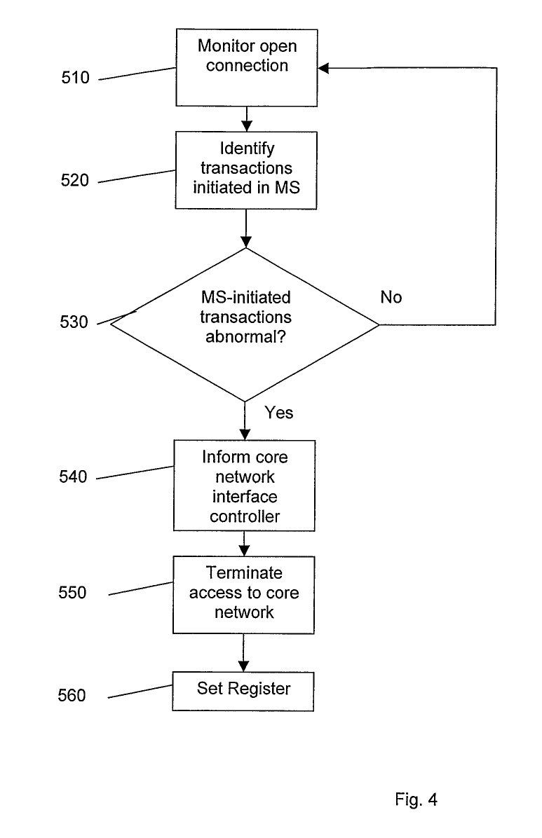

The function of the access controller 303 is illustrated in flow diagrams in FIGS. 3 and 4.

Turning to FIG. 3, the flow chart starts at step 400 with the receipt by the access controller AC 303 of a registration request from a mobile station MS 1. At step 410 the IMSI extractor 3031 retrieves the IMSI from the registration message and at step 420 extracts the MCC and MNC from the IMSI to form a PLMN identifier PLMN-Id. At step 430, the PLMN-Id is compared with the list or lists present in the memory 3032 to determine whether the mobile station belongs to an allowed operator. If the answer is yes, the method continues onto block 440. If, on the other hand, the answer is no, the method passes to block 490, the IMSI extractor informs the core network interface controller 3035 which denies the registration request. The method then terminates until another registration request is received. At block 440, the IMEI extractor obtains the International Mobile Equipment Identity from the registration message, or from a separate message forming part of the registration request. The IMEI then formulates a validation request containing this IMEI and sends it to the Equipment Identity Register, either via the mobile services switching center 202 MSC or to the EIR 205 in the core network directly. In accordance with a further variation, the IMEI extractor consults a local register or table provided in the access controller AC 303 and determines whether the IMEI of the mobile station is permitted. If the response to the query or the determination within the IMEI extractor comes back negative in step 460, the method moves on to block 490 and registration is denied to the mobile station. If the response is positive, the method then moves on to step 470, where the core network interface controller 3035 checks to see whether the register for barred mobile stations has been set. If the register is set at step 480, the method moves on to step 490 and registration is denied. If, conversely, the register is not set, the method passes on to step 500 and the mobile station is registered with the access controller 303.

Turning now to FIG. 4, the method continues after registration of the mobile station. At step 510 the transaction monitor 3034 watches the connection used between a single mobile station MS 1 and the access controller AC 303. This step also includes the monitoring of the communication between the mobile station and the mobile services switching center 202 of the core network that is relayed by the access controller 303. All transactions initiated in the mobile station MS 1 are logged at step 520. At step 530, it is determined whether the incidence of transactions initiated by the mobile station is too high, in other words whether the frequency with which the mobile station generates some transactions is unusual or if the information generated by the mobile station MS is otherwise abnormal. An example of abnormal behavior might be if the IMSI or the Packet Temporary Mobile Subscriber Identity P-TMSI contained in a Location Update Request differs from the value received during registration or attachment. If the answer is no, the method loops back to step 510 and monitoring continues. If, conversely, the incidence of the mobile station transactions is determined to be abnormally high or high enough to create disruption in the core network, the method passes on the step 540 and the transaction monitor informs the core network interface controller 3035. At step 550, the core network interface controller 3035 terminates the connection with the mobile station and at step 560 the core network interface controller 3035 sets the register, optionally with the timer. The register may be a memory area linked in some way with the identification of the mobile station, i.e. either the IMSI or the IMEI. Alternatively, the register may be a form of lookup table containing a mobile station identifier, in which individual entries are deleted after a predetermined time period. The register may include a list of mobile stations, for example, identified by the IMSI a combination of the IMSI with the IMEI, some derivative of these or a separate identifier that is linked at least to the IMSI. In this case, the register could be used by the IMSI extractor—and the IMEI extractor in those cases when no IMSI extractor is provided, or when the IMEI is verified first—such that when the retrieved identifier is stored in the register further checking for this mobile station is not carried out, but registration is denied immediately. In the method illustrated in FIG. 3 this would mean that step 470 should be performed between steps 410 and 420, i.e. between the retrieval of the IMSI and the verification of the validity of this IMSI at step 420.

It should be understood that while three functional blocks are shown in the access controller 303 and described with reference to the flow diagrams in FIGS. 3 and 4, any one of these functions may be provided independently of the others. For example, an access controller AC 303 may screen mobile stations according to the PLMN, but rely on the core network to provide the necessary equipment identity screening using the Equipment Identity Register EIR in accordance with a conventional PLMN operation. In this case, the method in FIG. 3 would pass from step 430 to step 470 or possibly directly to step 500. Similarly, the monitoring of the behavior of mobile stations after registration with the access network may be the only validation control provided in the access controller AC 303, or may be combined with only one or the other of the screening functions provided by the functional blocks 3031 and 3033.

It will be appreciated that the arrangement described above applies also to the use of the access network to provide the General Packet Radio Service GPRS to the mobile station. In such an arrangement, the access controller AC is connected via a Gb interface to a GPRS support node (SGSN) and will extract the subscriber and/or equipment identifiers and/or monitor the packet service traffic to the access controller and to the core network node in the same way as described above.

While the above arrangement and method have been described with specific reference to a GSM system it will be understood that the present invention can equally be applied to other cellular systems, such as UTMS or CDMA2000, for example. In all cases an equivalent subscriber identifier capable of indicating the operator to which the mobile station belongs may be used in place of the IMSI, while an equipment identifier can be used in place of the IMEI.

1. An access controller in an unlicensed radio access network, the access controller adapted to communicate with the core network portion of a public mobile communication network and connected to a broadband packet-switched network, said access controller being adapted to receive messages from mobile stations communicating via an unlicensed radio interface with access points connected to said broadband packet-switched network, said access controller comprising:
a screening module for monitoring information received from a mobile station and
a connection controller coupled to said screening module for controlling the connection between the mobile station and the access controller, wherein said screening module is adapted to determine whether a mobile station is permitted to connect to said access controller and said connection controller is adapted to terminate a connection with the mobile station if the screening module determines that the mobile station is not permitted to connect to the access controller.

2. The access controller in claim 1 wherein said screening module includes
a module for extracting at least part of a subscriber identity from information received from said mobile station to obtain a network operator identity for said mobile station, and
a table containing permitted and/or barred network operator identities coupled to said subscriber identity extractor module, said subscriber identity extractor module being adapted to compare an extracted network operator identity with network operator identities stored in said table to determine whether said extracted network operator identity is valid.

3. The access controller in claim 2, wherein said subscriber identity extractor module is adapted to extract at least part of a subscriber identity from a registration request received from said mobile station.

4. The access controller in claim 1, wherein said screening module includes
a module for extracting at least part of an equipment identity from information received from said mobile station and for comparing said extracted equipment identity with a list of permitted and/or barred equipment identities to determine whether said extracted equipment identity is authorised.

5. The access controller in claim 2, wherein said module for extracting at least part of a subscriber identity is adapted to extract at least part of a subscriber from a registration request received from said mobile station.

6. The access controller in claim 1, wherein said screening module includes
a module for monitoring traffic between said mobile station and said access controller and said mobile station and the core network portion, said monitoring module being adapted to signal to said connection controller to terminate the connection with said mobile station if said monitoring module determines that the pattern or nature of transactions initiated in said mobile station is abnormal.

7. The access controller in claim 6, wherein communication between a mobile station and said access controller takes place on an open connection, and said monitoring module is adapted to monitor an open connection between a mobile station and said access controller.

8. The access controller in claim 6, further comprising
a register associated with a mobile station and controlled by said connection controller, wherein said connection controller is adapted to set said register when the connection with said mobile station is terminated and to deny access to said mobile station while said register is set.

9. The access controller in claim 2, further comprising a timer adapted to reset said register after a predetermined time period.

10. An access controller in an unlicensed radio network the access controller adapted to communicate with the core network portion of a public mobile communication network and connected to a broadband packet-switched network, said access controller being adapted to receive messages from mobile stations communicating via an unlicensed radio interface with access points connected to said broadband packet-switched network, wherein said access controller comprises
a module for extracting at least part of a subscriber identity from information received from said mobile station to obtain a network operator identity for said mobile station,
a table containing permitted and/or barred network operator identities coupled to said subscriber identity extractor module, and
a connection controller coupled to said module for controlling the connection between the mobile station and the access controller, wherein said subscriber identity extractor module is adapted to compare an extracted network operator identity with network operator identities stored in said table to determine whether said extracted network operator identity is valid and said connection controller is adapted to terminate a connection with the mobile station if the extracted network operator identity is deemed invalid.

11. An access controller in an unlicensed radio network the access controller adapted to communicate with a core network portion of a public mobile communication network and connected to a broadband packet-switched network, said access controller being adapted to receive messages from mobile stations communicating via an unlicensed radio interface with access points connected to said broadband packet-switched network, wherein said access controller comprises
a module for extracting at least part of an equipment identity from information received from said mobile station and a connection controller coupled to said screening module for controlling the connection between the mobile station and the access controller, wherein said equipment identity extracting module is adapted to comparing said extracted equipment identity with a list of permitted and/or barred equipment identities to determine whether said extracted equipment identity is authorised and said connection controller is adapted to terminate a connection with the mobile station if the equipment identity is deemed not authorised.

12. An access controller in an unlicensed radio network the access controller adapted to communicate with a core network portion of a public mobile communication network and connected to a broadband packet-switched network, said access controller being adapted to receive messages from mobile stations communicating via an unlicensed radio interface with access points connected to said broadband packet-switched network, said access controller comprising:
a module for monitoring traffic between said mobile station and said access controller and said mobile station and the core network portion; and
a connection controller coupled to said screening module for controlling the connection between the mobile station and the access controller, wherein said monitoring module is adapted to determine whether the pattern or nature of transactions initiated in said mobile station is abnormal and said connection controller is adapted to terminate a connection with the mobile station if the pattern or nature of transactions initiated in said mobile station is deemed abnormal.

13. A method of validating a mobile station in an unlicensed radio access network, wherein the unlicensed radio access network includes an access controller adapted to communicate with the core network portion of a public mobile communication network and connected to a broadband packet-switched network, said access controller being adapted to receive messages from mobile stations communicating via an unlicensed radio interface with access points connected to said broadband packet-switched network, said method comprising the steps of:
monitoring information received from a mobile station to determine whether a mobile station is permitted to connect to said access controller, and
terminating a connection with the mobile station if it is determined the mobile station is not permitted to connect to the access controller.

14. The method in claim 10, wherein the step of monitoring information includes
extracting at least part of a subscriber identity from said received information to obtain a network operator identity for said mobile station, and
comparing said extracted identity with permitted and/or barred network operator identities to determine whether said extracted network operator identity is valid.

15. The method in claim 11, wherein the step of monitoring information includes
extracting at least part of an equipment identity from information received from said mobile station, and
comparing said extracted equipment identity with a list of permitted and/or barred equipment identities to determine whether said extracted equipment identity is authorised.

16. The method in claim 11, wherein the step of monitoring information includes
monitoring traffic between said mobile station and said access controller and between said mobile station and the core network portion, and
said terminating step includes terminating the connection with said mobile station if it is determined that the pattern or nature of transactions initiated in said mobile station is abnormal.
